(19) United States
(12) Patent Application Publication
(10) Pub. No.: US 2012/0287972 A1
(43) Pub. Date: Nov. 15, 2012

(54) SYSTEM AND METHOD FOR COMMUNICATING DATA IN A PASSENGER VEHICLE OR OTHER VEHICLE CONSIST

(75) Inventors: Joseph F. Noffsinger, Lee's Summitt, MO (US); Michael Mitchell, Lee's Summit, MO (US); Paul Gutauskas, Blue Springs, MO (US); Jeffrey Smith, Lee's Summitt, MO (US); Jared Cooper, Palm Bay, FL (US); Todd Goodermuth, Satellite Beach, FL (US); Eugene Smith, Satellite Beach, FL (US)

(73) Assignee: GENERAL ELECTRIC COMPANY, Schenectady, NY (US)

(21) Appl. No.: 13/523,967

(22) Filed: Jun. 15, 2012

Related U.S. Application Data
(63) Continuation-in-part of application No. 12/683,874, filed on Jan. 7, 2010.
(60) Provisional application No. 61/498,152, filed on Jun. 17, 2011.
(60) Provisional application No. 61/160,930, filed on Mar. 17, 2009.

(51) Int. Cl. H04B 3/00; H04B 1/38

(52) U.S. Cl. 375/219; 375/257

(57) ABSTRACT

A passenger vehicle consist includes a plurality of passenger vehicles and an electrical power transmission line interconnecting the plurality of passenger vehicles. A system for communicating data in the vehicle consist includes first unit on a first vehicle in the consist and a second unit on a second vehicle in the consist. The first and second units are electrically coupled to an electrical power transmission line in the consist that interconnections adjacent vehicles. The electrical power transmission line is an existing line used in the vehicle consist for transferring electrical power to the vehicles in the consist. The first and second units are configured to transmit and/or receive at least one of high-bandwidth data or network data over the electrical power transmission line.

### CROSS REFERENCE TO RELATED APPLICATIONS

This application claims priority to U.S. provisional application Ser. No. 61/498,152, filed Jun. 17, 2011, incorporated by reference herein in its entirety. This application is also a continuation-in-part of, and claims priority to, U.S. patent application Ser. No. 12/683,874, filed Jan. 7, 2010, which claims priority to U.S. provisional application Ser. No. 61/160,930, filed Mar. 17, 2009.

### FIELD OF THE INVENTION

Embodiments of the invention relate to data communications. Other embodiments relate to data communications in a passenger vehicle consist or other vehicle consist.

### BACKGROUND OF THE INVENTION

A passenger train consist is a group of two or more passenger vehicles that are mechanically coupled or linked together to travel along a route. As used herein, “passenger train” or “passenger vehicle” is intended to mean rolling stock used in main line passenger and public and private transit railway operations including but not limited to passenger cars, power cars, control cars, dining, sleeping, baggage cars, or mail cars in coupled or individual operation; integrated trainsets for passenger operations consisting of two or more permanently (or semi-permanently) connected cars, power cars, control cars, baggage cars, or mail cars operated as a unit, typically articulated; or any combination of trainsets and individual cars coupled together. These vehicles are used in operations described as passenger rail, high speed rail, commuter rail, rail transit, metro, light rail, trams, tramways, or train-tram.

In contrast to freight trains made up of freight locomotives and freight car(s) (wagon(s)), rolling stock in passenger service may be fitted with but not limited to one or more of the following, depending on the type of train and service: seating for persons beyond the train operating crew, grab bars for standing passengers, sleeping berths or bedrooms, parlors, dining facilities, bicycle racks, baggage storage areas, and express mail facilities. Control cabs and propulsion systems may be contained within one of these service cars, or may be on a separate dedicated vehicle such as a locomotive. Unlike a freight train consist, the cars of a passenger train, and in turn the train itself, are usually fitted with electrical power for lighting, and optional electric or pneumatic door systems, passenger information systems (public address or signage), alarm systems, and other specialized functions. Seating may range from no seats in a bicycle carrier or “stand-up” people carrier such as an airport people mover, to 100 or more seats in a bi-level passenger car for suburban or main line rail service. Provision for wheel chair access and tie downs are often provided.

Passenger and transit trains are connected through the consist with an electrical power transmission line. The electrical power transmission line links the passenger vehicles in the consist such that electrical power may be distributed from a locomotive, control cab, or other passenger vehicle in the consist to the other passenger vehicles in the consist. The electrical power transmission line provides electrical power to run electronics or other systems on-board the passenger vehicles, such as the lighting, automatic door systems, passenger information systems, alarm systems, etc.

In some cases, it may be desirable to link the on-board electronics together as a computer network, such that electronics of a lead locomotive, control cab, or passenger vehicle in the consist can communicate with electronics and systems of the other passenger vehicles. Heretofore, communications in a passenger train consist have been realized using various methods. A first method involves wireless communications between the passenger vehicles in the consist using radio equipment. Wireless communications, however, are costly to implement, and are particularly prone to cross talk between connected vehicles and vehicles not physically connected on adjacent tracks. A second method involves running dedicated network cables between the linked passenger vehicles in a consist. However, in most cases this requires retrofitting existing vehicles with additional cables, which is oftentimes cost prohibitive. Indeed, installation of additional connectors and wiring is expensive, increases downtime, and lowers reliability of the trainset. Additionally, since the cabling is exposed in the separation space between adjacent linked locomotives, the cabling may be prone to failure if the vehicle consist is operated in harsh environmental conditions, e.g., bad weather. There is also additional labor required to connect passenger vehicles with dedicated network cables, and this will require additional training. Finally, installing additional functions or upgrading functions such as positive train control (PTC) or passenger information systems require additional connectivity which may necessitate that even more cabling be run between the passenger vehicles in the consist, especially for older passenger trains that are not equipped with high level function connectivity.

### BRIEF DESCRIPTION OF THE INVENTION

An embodiment relates to a communication system for communicating data in a vehicle consist. The system comprises a first unit on a first vehicle in the vehicle consist and a second unit on a second vehicle in the vehicle consist. The first and second units are electrically coupled to an electrical power transmission line (or other electrical conductor) in the vehicle consist that interconnections adjacent vehicles. For example, the electrical power transmission line may be an existing line used in the vehicle consist for transferring electrical power to the vehicles in the vehicle consist. The first and second units are configured to transmit and/or receive at least one of high-bandwidth data or network data over the electrical power transmission line or other electrical conductor.

In another embodiment of the communication system, the first and second units are configured to convert the network data into modulated network data for transmission over the electrical power transmission line, and to de-modulate modulated network data received over the electrical power transmission line back into network data, for use in communicating data between electronic components in the vehicle consist or otherwise.

In an embodiment, the first and second units are router transceiver units. Each of the router transceiver units comprise a network adapter module electrically connected to an electronic component and a signal modulator module having an electrical output for electrical connection to the electrical power transmission line.

In an embodiment, the first and second units are configured to measure a length of the vehicle consist by measuring at least one event between a front vehicle and a rear vehicle in the vehicle consist, assess consist integrity through at least one of continuous or polling communications with a rear vehicle in the vehicle consist, determine a position of one or more vehicles in the consist by synchronizing one or more measured events, and/or determine a relationship, such as a distance, between the first vehicle and the second vehicle.

In other embodiments, the first unit is configured to determine that a first electronic component in the first vehicle is in a failure state. “Failure state” means that the first electronic component is unable to perform a designated function. The system further comprises a first data transmitter module configured to transmit the high-bandwidth or network data from the first vehicle to the second vehicle in response to the first unit determining that the first electronic component is in the failure state.

In yet other embodiments, the first and second units are configured to transmit video data over the electrical power transmission line and to display or process the video data for clearing doors at an unload/load platform and/or are controlled to access one or more of redundant communications, public information systems, and/or train control equipment over the electrical power transmission line.

Another embodiment relates to a data communications network for passenger vehicles in a vehicle consist. The system comprises a first unit on a first passenger vehicle in the vehicle consist and a second unit on a second passenger vehicle of the consist. The first and second units are coupled to an electrical power transmission line (or other electrical conductor) in the vehicle consist that interconnects adjacent passenger vehicles. The electrical power transmission line may be an existing line used in the vehicle consist for transferring electrical power to the passenger vehicles in the vehicle consist. The first and second units are configured to transmit and/or receive at least one of network data or high-bandwidth data over the electrical power transmission line (or other electrical conductor).

Another embodiment relates to a communication system for communicating data in a vehicle consist. The system comprises a first unit configured for operable coupling with an electrical power transmission line (or other electrical conductor) in a first vehicle. The electrical power transmission line is configured to interconnect the first vehicle with adjacent vehicles in the vehicle consist for transferring electrical power within the vehicle consist when the first vehicle is mechanically coupled to the adjacent vehicles. The first unit is further configured to transmit and/or receive at least one of high-bandwidth data or network data over the electrical power transmission line. In an embodiment, electrical power is non-data electricity, meaning electricity that is not used to convey information.

In another embodiment, the first unit is configured to measure a length of the vehicle consist by measuring at least one event between a front vehicle and a rear vehicle in the vehicle consist, assess consist integrity through at least one of continuous or polling communications with a rear vehicle in the vehicle consist, verify a status of the vehicle consist by polling one or more vehicles in the consist, determine a position of one or more vehicles in the vehicle consist by synchronizing one or more measured events, and/or determine a relationship, such as a distance, between the first vehicle and the second vehicle.

In another embodiment, the first unit is configured to determine that a first electronic component in the first vehicle is in a failure state. The system further comprises a first data transmitter module configured to transmit the high-bandwidth and/or network data from the first vehicle to the second vehicle in response to the first unit determining that the first electronic component is in the failure state.

In another embodiment, the first unit is configured to convert the network data into modulated network data for transmission over the electrical power transmission line and to demodulate the modulated network data received over the electrical power transmission line for use by electronic components in the vehicles of the vehicle consist.

In another embodiment, the first unit is a router transceiver unit. The router transceiver unit comprises a network adapter module electrically connected to an electronic component, and a signal modulator module having an electrical output for electrical connection to the electrical power transmission line.

In yet other embodiments, the first unit is configured to transmit video data over the electrical power transmission line and to display or process the video data for clearing doors at an unload/load platform and/or are controlled to access one or more of redundant communications, public information systems, and/or train control equipment over the electrical power transmission line.

In any of the aforementioned embodiments, the network data may be TCP/IP-formatted data; other communications protocols may be used. Additionally, each locomotive, other rail vehicle, or other vehicle may include computer units or other electronic components communicating with other electronic components in the same consist by transmitting the network data, formatted as TCP/IP data or otherwise, over the electrical power transmission line, thereby forming a computer network, e.g., an Ethernet-type network.

Any of the aforementioned embodiments are also applicable for communicating data in vehicle consists generally. “Vehicle consist” refers to a group of vehicles that are mechanically coupled or linked together to travel along a route. Moreover, in any of the aforementioned embodiments, the vehicle consist may be a passenger vehicle consist comprising a plurality of passenger vehicles. “Passenger vehicle consist” means a group of passenger vehicles that are mechanically coupled or linked together to travel along a set of one or more rails.

In any of the aforementioned embodiments, the physical communication link between vehicles in the consist may be other than an electrical power transmission line. In any such embodiments, the physical communication link may be a cable or other electrical conductor extending between plural and/or adjacent passenger cars, other than an electrical power transmission line.

### BRIEF DESCRIPTION OF THE DRAWINGS

The present invention will be better understood from reading the following description of non-limiting embodiments, with reference to the attached drawings, wherein below:

FIG. 1 is a schematic diagram of a communication system for communicating data in a passenger vehicle consist, according to an embodiment of the present invention;

FIG. 2 is a schematic diagram of an electrical power transmission line, shown in the context of the communication system of FIG. 1;

FIG. 3 is a schematic diagram of a router transceiver unit according to an embodiment of the present invention;

FIG. 4 is a schematic diagram illustrating the functionality of a signal modulator module portion of a router transceiver unit, according to an embodiment of the present invention; and

FIG. 5 is a circuit diagram of another embodiment of a router transceiver unit.

### DETAILED DESCRIPTION OF THE INVENTION

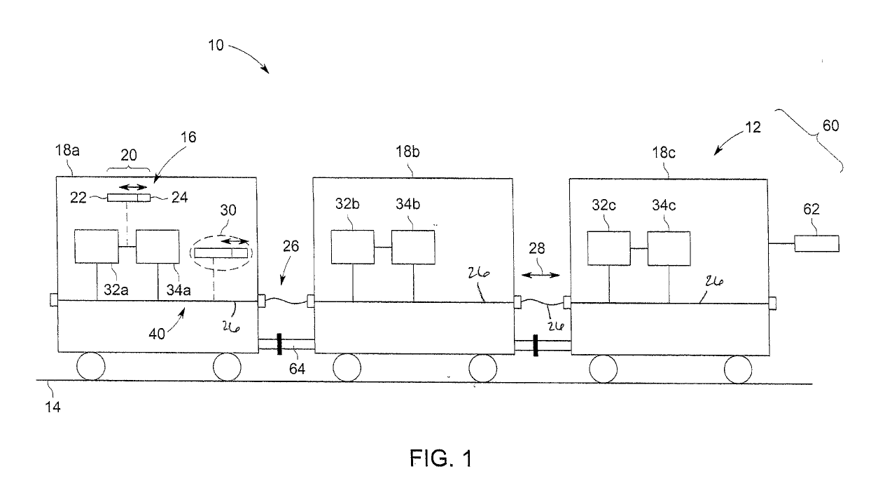

With reference to FIG. 1, embodiments of the present invention relate to a communication system 10 for communicating data in a passenger train consist 12. “Passenger train consist” refers to a group of passenger vehicles that are mechanically coupled or linked together to travel along a railway 14. In the system 10, network and/or high-bandwidth data 16 is transmitted from one passenger vehicle 18a in the consist 12 (e.g., a first passenger vehicle or control cab 18a) to another passenger vehicle 18b in the consist (e.g., a trail passenger vehicle 18b for accommodating passengers). Each vehicle 18a-18c is adjacent to and mechanically coupled with another vehicle in the consist 12 such that all vehicles in the consist are connected. “Network data” 16 refers to data that is packaged in packet form, meaning a data packet that comprises a set of associated data bits 20. (Each data packet may include a data field 22 and a network address or other address 24 uniquely associated with a computer unit or other electronic component in the consist 12.) “High-bandwidth data” refers to data that is transmitted at average rates of 10 Mbit/sec or greater. The network data 16/high-bandwidth data is transmitted over an electrical power transmission line 26. The electrical power transmission line 26 is an existing line interconnecting the control cab 18a and the trail passenger vehicles 18b, 18c in the consist 12 that provides electrical power to run electronics or other systems on-board the passenger vehicles, such as lighting. As used herein, “electrical power” is to be distinguished from electrical signals, e.g., data, transmitted over the electrical power transmission line. For example, “electrical power” is non-data electricity, meaning electricity that is not used to convey information. In addition, electrical power may be in the range of multiple amperes and/or multiple thousands of watts.

In an embodiment, the electrical power transmission line 26 may also used in the passenger vehicle consist 12 for transferring non-network control information 28 between passenger vehicles in the consist. “Non-network” control information 28 refers to data or other information, used in the passenger vehicle consist for control purposes, which is not packet data. In another aspect, non-network control information 28 is not packet data, and does not include recipient network addresses.

In another embodiment, as discussed in more detail below, the network data 16 is converted into modulated network data 30 for transmission over the electrical power transmission line 26. At recipient/subsequent passenger vehicles, the modulated network data 30 is received over the electrical power transmission line 26 and de-modulated for use by a passenger vehicle electronic component/unit 32a, 32b, 32c. For these functions, the communication system 10 may comprise respective router transceiver units 34a, 34b, 34c positioned in the control cab 18a and each of the passenger vehicles 18b, 18c in the passenger train consist 12.

By using an existing inter-vehicle electrical power transmission line for transmitting network data and high-bandwidth data between vehicles in the consist, the system and method of the present invention avoids interference and other problems associated with wireless transmissions, and obviates the need to specially outfit the passenger vehicles with dedicated network cables. In addition, it obviates the need to run additional cabling between the passenger vehicles to provide for the installation of additional functions or upgrading functions that require additional connectivity, especially on trains that are not already equipped with some form of high level function connectivity.

In an embodiment, the transmission of data over the existing electrical power transmission line 26 interconnecting the passenger cars 18a-18c of the consist 12 allows for the availability of additional functions or for upgrading functions such as positive train control (PTC), automatic door systems and passenger/public information systems on the passenger vehicle consist 12. Examples of higher level functions or features are described hereinafter. For example, in an embodiment, one of the electronic components 32a-32c may be configured to measure a length of the vehicle consist by measuring at least one event between a front vehicle and a rear vehicle in the consist. In another embodiment, one or more of the electronic components 32a-32c are configured to assess consist integrity through continuous or polling communications with a rear vehicle in the consist, determine a position of one or more vehicles in the consist by synchronizing one or more measured events between selected passenger vehicles 18a-18c in the consist 12, and/or determine a distance between selected passenger vehicles 18a-18c, such as a first and second passenger vehicle. In addition, the system 10 may poll individual passenger vehicles 18a-18c that are equipped with an electronic component 32a-32c through the transmission of signals/data over the electrical power transmission line 26.

In another embodiment, one or more of the electronic components 32a-32c are configured to transmit video data over the electrical power transmission line 26 and to display or process the video data for clearing doors at an unload/load platform such that passengers may unload from and/or load onto the passenger vehicles 18a-18c while being safely monitored. In another embodiment, one or more of the electronic components 32a-32c may be configured or controlled to access one or more of redundant communications, public information systems and train control equipment over the electrical power transmission line. The controlling of public information systems may include controlling PA systems, e.g., linking speakers such that information or commands may be automatically broadcast to all or select locomotives at desired times. In addition, the controlling of public information systems may include the controlling of alarms at one or more of the passenger vehicles 18a-18c from another of the passenger vehicles, such as a control cab.

Through the linking of the vehicles 18a-18c through the electrical power transmission line 26, and the transmission of data thereover, access to redundant communications is provided. In an embodiment, an electronic component, e.g., electronic component 32a, can determine that another electronic component, such as a PA system on another passenger vehicle, is in a failure state. A failure state is where the electronic component is unable to perform its function. Accordingly, the system 10, through data transmission over the electrical power transmission line 26, is capable of determining when another electronic component is in a failure state, and can then transmit data in the form of commands, e.g., from a data transmitter module, to another electronic component on a different passenger vehicle that is capable of performing the same function, such that functionality of the failed component is not lost throughout the entire consist 12. This same redundant communications functionality may also be utilized for train control equipment. In an embodiment, the system 10 is able to link, in a communications sense, a front control cab and a rear control cab. Accordingly, as a result of the transmission of data over the existing electrical power transmission line 26, in an embodiment, the system 10 can provide for enhanced feature availability when driving from a rear control cab, without having to retrofit the consist 12 with other cabling, wires or the like.

In an embodiment, the transmission of data across the existing electrical power transmission line 26 permits the implementation of higher function systems and control features with minimum effort and expense, e.g., without having to install additional wires, cables connectors and the like. Moreover, this higher-level functionality may even be added to older cars that do not have higher-level function connectivity by utilizing only the vehicle-to-vehicle power connections, i.e., the existing electrical power transmission line 26.

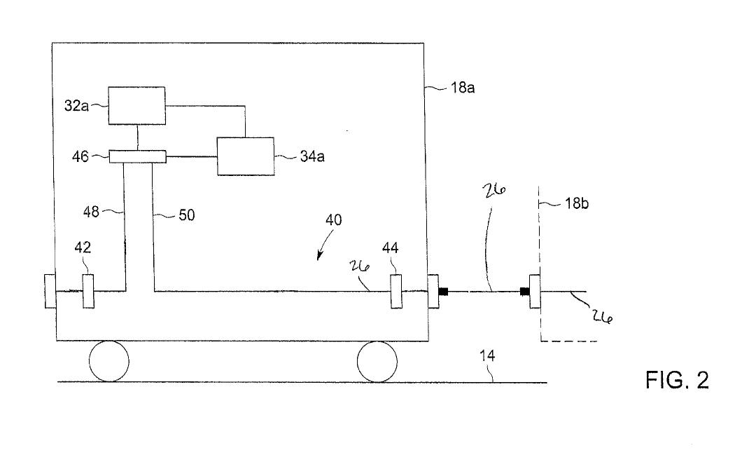

A schematic diagram illustrating the path of the electrical power transmission line 26 is shown in FIG. 2. As noted above, the electrical power transmission line 26 is an existing cable interconnecting the control cab 18a and the passenger vehicles 18b, 18c in the consist. In each vehicle, e.g., the control cab 18a as shown in FIG. 2, the electrical power transmission line may connect to an internal electrical system 40 including one or more electronic components 32a of the control cab 18a. In the illustrated example, the internal electrical system 40 comprises a front terminal board 42 and a rear terminal board 44 electrically connected to the electrical power transmission line 26, a central terminal board 46, and first and second electrical conduit portions 48, 50 electrically connecting the central terminal board 46 to the front terminal board 42 and the rear terminal board 44, respectively. The one or more electronic components/units 32a of the control cab 18a may be electrically connected to the central terminal board 46, and thereby to the electrical power transmission line 26 generally. Although the electrical power transmission line 26 may connect the passenger vehicles 18a, 18b and 18c at the respective front and rear thereof, this is not always the case, and designations such as “front,” “rear,” “central,” etc. are not meant to be limiting but are instead provided for identification purposes.

The central terminal board 46, front terminal board 42, and rear terminal board 44 each comprise an insulating base (attached to the vehicle) on which terminals for wires or cables have been mounted. This provides flexibility in terms of connecting different electronic components.

The electrical power transmission line 26 may used in the passenger train consist 12 for transferring non-network control information 28 between vehicles/passenger vehicles 18a, 18b, 18c in the consist. “Non-network” control information 28 refers to data or other information, used in the passenger vehicle consist for control purposes, which is not packet data. In another example, non-network control information 28 is not packet data, and does not include recipient network addresses. The non-network control information 28 is transmitted and received over the electrical power transmission line 26 using one or more electronic components 32a-32c in each passenger vehicle that are configured for this purpose.

As indicated in FIG. 1, the passenger vehicle consist 12 may be part of a train 60 that includes the passenger vehicle consist 12, a plurality of other cars 62, and possibly additional locomotives, control cabs, mail cars, etc. (not shown). Each passenger vehicle 18a-18c in the consist 12 is mechanically coupled to at least one other, adjacent passenger vehicle in the consist 12, through a coupler 64. The other cars 62 are similarly mechanically coupled together and to the passenger vehicle consist to form a series of linked vehicles. The non-network control information may be used for passenger vehicle control purposes or for other control purposes in the train 60.

As discussed above, the communication system 10 may comprise respective router transceiver units 34a, 34b, 34c positioned in the control cab 18a and each of the other passenger vehicles 18b, 18c in the passenger vehicle consist 12. The router transceiver units 34a, 34b, 34c are each electrically coupled to the electrical power transmission line 26. The router transceiver units 34a, 34b, 34c are configured to transmit and/or receive network data 16 or high-bandwidth data over the electrical power transmission line 26. In one embodiment, each router transceiver unit receives network data 16 from a computer unit or other electronic component 32a, 32b, 32c in the passenger vehicle consist 12, and modulates the received network data 16 into modulated network data 30 for transmission over the electrical power transmission line 26. Similarly, each router transceiver unit 34a, 34b, 34c receives modulated network data 30 over the electrical power transmission line 26 and de-modulates the received modulated network data 30 into network data 16. “Modulated” means converted from one form to a second, different form suitable for transmission over the electrical power transmission line 26. “De-modulated” means converted from the second form back into the first form. At recipient/subsequent passenger vehicles, the modulated network data 30 is received over the electrical power transmission line 26 and de-modulated back into the network data 16 for use by a passenger vehicle electronic component 32a, 32b, 32c, such as a computer, passenger information system, lighting system, etc.

The network data 16 is data that is packaged in packet form, meaning a data packet that comprises a set of associated data bits 20. Each data packet 20 may include a data field 22 and a network address or other address 24 uniquely associated with a computer unit or other electronic component 32a-32c in the consist 12. The network data 16 may be TCP/IP-formatted or SIP-formatted data, however, the electronic components and/or router transceiver units may use other communications protocols for communicating network data. As should be appreciated, the electrical power transmission line 26, electronic component 32a-32c, and router transceiver units 34a-34c together form a high-bandwidth local area network.

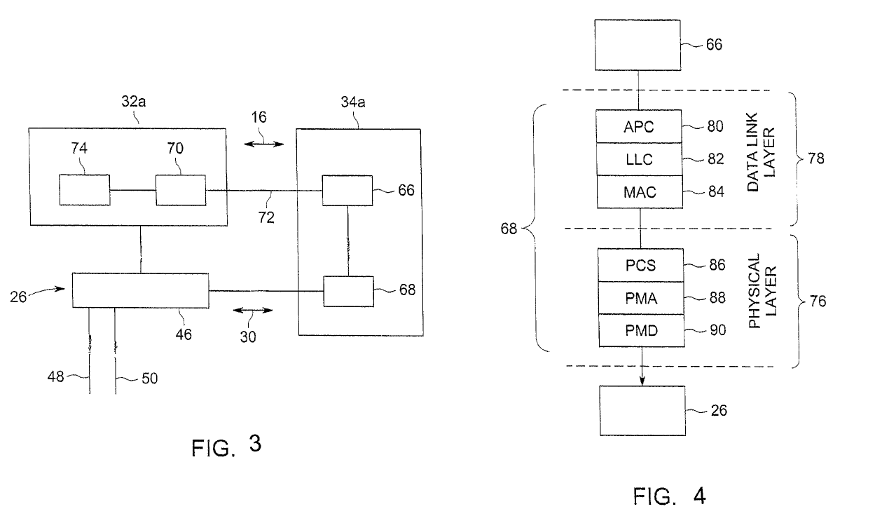

FIG. 3 shows one embodiment of a router transceiver unit 34a in more detail. The router transceiver unit 34a comprises a network adapter module 66 and a signal modulator module 68. The signal modulator module 68 is electrically connected to the network adapter module 66 and to the electrical power transmission line 26. In the example shown in FIG. 3, the signal modulator module 68 is electrically connected to the electrical power transmission line 26 by way of the central terminal board 46, near a passenger vehicle electronic component 32a. The network adapter module 66 is electrically connected to a network interface unit 70 that is part of and/or operably connected to the electronic component 32a. (The electronic component 32a may be, for example, a computer unit for controlling a system deployed on a passenger vehicle or a system itself, such as automatic doors, a passenger information system, lighting, etc.) The network adapter module 66 and network interface unit 70 are electrically interconnected by a network cable 72. For example, if the network adapter module 66 and network interface unit 70 are configured as an Ethernet local area network, the network cable 72 may be a CAT-5E cable. The network interface unit 70 is functionally connected to one or more software or hardware applications 74 in the electronic component 32a that are configured for network communications. In one embodiment, the network interface unit 70, network cable 72, and software or hardware applications 74 include standard Ethernet-ready (or other network) components. For example, if the electronic component 32a is a computer unit, the network interface unit 70 may be an Ethernet adapter connected to computer unit for carrying out network communications.

The network adapter module 66 is configured to receive network data 16 from the network interface unit 70 over the network cable 72. The network adapter module 66 conveys the network data 16 to the signal modulator module 68, which modulates the network data 16 into modulated network data 30 and transmits the modulated network data 30 over the electrical power transmission line 26. The signal modulator module 68 also receives modulated network data 30 from over the electrical power transmission line 26 and de-modulates the modulated network data 30 into network data 16, which it then conveys to the network adapter module 66 for transmission to the network interface unit 70. One or both of the network adapter module 66 and the signal modulator module 68 may perform various processing steps on the network data 16 and/or the modulated network data 30 for transmission and reception both over the electrical power transmission line 26 and/or over the network cable 72 (to the network interface unit 70). Additionally, one both of the network adapter module 66 and the signal modulator module 68 may perform network data routing functions.

The signal modulator module 68 includes an electrical output (e.g., port, wires) for electrical connection to the electrical power transmission line 26, and internal circuitry (e.g., electrical and isolation components, microcontroller, software/firmware) for receiving network data 16 from the network adapter module 66, modulating the network data 16 into modulated network data 30, transmitting the modulated network data 30 over the electrical power transmission line 26, receiving modulated network data 30 over the electrical power transmission line 26, de-modulating the modulated network data 30 into network data 16, and communicating the network data 16 to the network adapter module 66. The internal circuitry may be configured to modulate and de-modulate data using schemes such as those utilized in VDSL or VHDSL (very high bitrate digital subscriber line) applications, or in power line digital subscriber line (PDSL) applications. One example of a suitable modulation scheme is orthogonal frequency-division multiplexing (OFDM). OFDM is a frequency-division multiplexing scheme wherein a large number of closely-spaced orthogonal sub-carriers are used to carry data. The data is divided into several parallel data streams or channels, one for each sub-carrier. Each sub-carrier is modulated with a conventional modulation scheme (such as quadrature amplitude modulation or phase shift keying) at a low symbol rate, maintaining total data rates similar to conventional single-carrier modulation schemes in the same bandwidth.

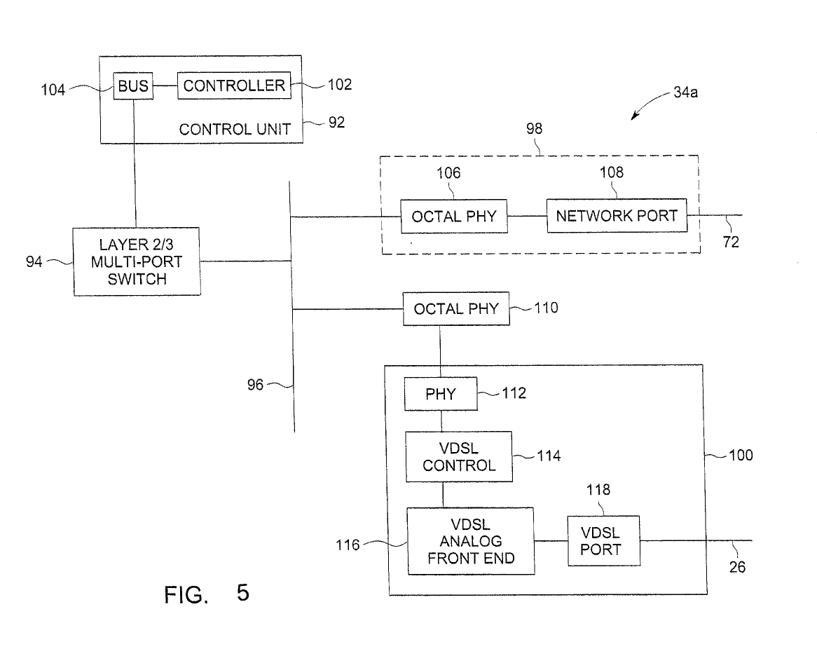

FIG. 4 shows one possible example of how the signal modulator module 68 could function, cast in terms of the OSI network model, according to one embodiment of the present invention. In this example, the signal modulator module 68 includes a physical layer 76 and a data link layer 78. The data link layer 78 is divided into three sub-layers. The first sub-layer is an application protocol convergence (APC) layer 80. The APC layer accepts Ethernet (or other network) frames 16 from an upper application layer (e.g., the network adapter module 66) and encapsulates them into MAC (medium access control) service data units, which are transferred to a logical link control (LLC) layer 82. The LLC layer 82 is responsible for potential encryption, aggregation, segmentation, automatic repeat-request, and similar functions. The third sub-layer of the data link layer 78 is a MAC layer 84, which schedules channel access. The physical layer 76 is divided into three sub-layers. The first sub-layer is a physical coding sub-layer (PCS) 86, which is responsible for generating PHY (physical layer) headers. The second sub-layer is a physical medium attachment (PMA) layer 88, which is responsible for scrambling and FEC (forward error correction) coding/decoding. The third sub-layer is a physical medium dependent (PMD) layer 90, which is responsible for bit-loading and OFDM modulation. The PMD layer 90 is configured for interfacing with the electrical power transmission line 26

FIG. 5 is a circuit diagram of another embodiment of a router transceiver unit 34a. In this embodiment, the router transceiver unit 34a comprises a control unit 92, a switch 94, a main bus 96, a network interface portion 98, and a VDSL module 100. The control unit 92 comprises a controller 102 and a control unit bus 104. The controller 102 is electrically connected to the control unit bus 104 for communicating data over the bus 104. The controller 102 may be a microcontroller or other processor-based unit, including support circuitry for the microcontroller. The switch 94 is a network switching/router module configured to process and route packet data and other data. The switch 94 interfaces the control unit 92 with the main bus 96. The switch 94 may be, for example, a layer 2/3 multi-port switch. The network interface portion 98 is electrically connected to the main bus 96, and comprises an octal PHY (physical layer) portion 106 and a network port portion 108. The network port portion 108 is electrically connected to the octal PHY portion 106. The octal PHY portion 106 may comprise a 10/100/1000 Base T 8-port Ethernet (or other network) transceiver circuit. The network port portion 108 may comprise an Ethernet (or other network) transformer and associated CAT-5E receptacle (or other cable type receptacle) for receiving a network cable 72.

The VDSL module 100 is also connected to the main bus 96 by way of an octal PHY unit 110, which may be the same unit as the octal PHY portion 106 or a different octal PHY unit. The VDSL module 100 comprises a physical interface portion (PHY) 112 electrically connected to the octal PHY unit 110, a VDSL control 114 electrically connected to the physical interface portion 112, a VDSL analog front end unit 116 electrically connected to the VDSL control 114, and a VDSL port unit 118 electrically connected to the VDSL analog front end unit 116. The physical interface portion 112 acts as a physical and electrical interface with the octal PHY unit 110, e.g., the physical interface portion 112 may comprise a port and related support circuitry. The VDSL analog front end unit 116 is configured for transceiving modulated network data 30 (e.g., sending and receiving modulated data) over the electrical power transmission line 26, and may include one or more of the following: analog filters, line drivers, analog-to-digital and digital-to-analog converters, and related support circuitry (e.g., capacitors). The VDSL control 114 is configured for converting and/or processing network data 16 for modulation and de-modulation, and may include a microprocessor unit, ATM (asynchronous transfer mode) and IP (Internet Protocol) interfaces, and digital signal processing circuitry/functionality. The VDSL port unit 118 provides a physical and electrical connection to the electrical power transmission line 26. Overall operation of the router transceiver unit 34a shown in FIG. 5 is similar to what is described in relation to FIGS. 1-3.

With reference to the above-described system 10, electronic components of the router-transceiver units 34a-34c may be adjusted based on the electrical characteristics of the electrical power transmission line 26, and/or additional electronic components (e.g., noise filters/processors) may be added to the system to compensate for specific aspects/characteristics of the power transmission line 26.

Another embodiment of the invention relates to a method for communicating data in a passenger vehicle consist 12. The method comprises transmitting network data 16, 30 and/or high-bandwidth data between passenger vehicles 18a-18c within a passenger vehicle consist 12. (Each passenger vehicle 18a-18c is adjacent to and mechanically coupled with one or more other passenger vehicles in the consist.) The network data 16, 30 and/or high-bandwidth data is transmitted over an electrical power transmission line 26 interconnecting at least adjacent passenger vehicles 18a, 18b in the consist 12. The electrical power transmission line 26 is an existing line used in the passenger vehicle consist 12 for providing electrical power to run electronics or other systems on-board the passenger vehicles, such as lighting.

In another embodiment, the method further comprises, at each of one or more of the passenger vehicles 18a-18c in the passenger vehicle consist 12, converting the network data 16 into modulated network data 30 for transmission over the electrical power transmission line 26. The method further comprises de-modulating the modulated network data 30 received over the electrical power transmission line 26 for use by on-board electronic components 32a-32c of the passenger vehicles, such as lighting, automatic door systems, passenger information systems, alarm systems, etc.

As should be appreciated, it may be the case that certain passenger vehicles in a consist are network equipped according to the system and method of the present invention, e.g., outfitted with a router transceiver unit, and that other passenger vehicles in the consist are not. For example, there may be first and third network-equipped passenger vehicles physically separated by a second passenger vehicle that is not network equipped. In this case, the first and third passenger vehicles are still able to communicate and exchange data even though there is a non-network equipped passenger vehicle between them. This is possible because all the passenger vehicles are still electrically connected via the electrical power transmission line. In one case, for example, a passenger vehicle consist comprises first, second, and third passenger vehicles, with the second passenger vehicle being disposed between the first and third passenger vehicles. A first router transceiver unit is positioned in the first passenger vehicle, and a second router transceiver unit is positioned in the third passenger vehicle. The second passenger vehicle, however, does not have a router transceiver unit or other functionality for transmitting and/or receiving network data/high-bandwidth data over the electrical power transmission line. Nevertheless, network data/high-bandwidth data is transmitted between the first and third passenger vehicles through the second passenger vehicle, with the network data/high-bandwidth data passing through the electrical power transmission line in the second passenger vehicle but not being transmitted or received by the second passenger vehicle.

In another embodiment, the method further comprises controlling an electronic system or component on at least one of the passenger vehicle 18a-18c in the consist based at least in part on the network data 16/high-bandwidth data.

The passenger vehicle consist 12 may be part of a train 60 that comprises the passenger vehicle consist 12 and a plurality of other 62.

Another embodiment of the present invention relates to a communication system 10 for communicating data in a passenger vehicle consist 12. The system 10 comprises a respective router transceiver unit 34a-34c positioned in each passenger vehicle 18a-18c of a passenger vehicle consist 12. Each router transceiver unit 34a-34c is coupled to a electrical power transmission line 26 in the passenger vehicle consist 12 that interconnects and provides power to adjacent passenger vehicles 18a, 18b. Each router transceiver unit 34a-34c is configured to transmit and/or receive network data 16, 30/high-bandwidth data over the electrical power transmission line 26.

In another embodiment of the system 10, each router transceiver unit 34a-34c is configured to convert the network data 16 into modulated network data 30 for transmission over the electrical power transmission line 26. Each router transceiver unit is further configured to de-modulate the modulated network data received over the electrical power transmission line for use by electronic components in the passenger vehicles of the consist.

While the above-described embodiments disclose the transmission of network data over a physical communication link between vehicles in the consist, the physical communication link being an electrical power transmission line, in any of the aforementioned embodiments, the physical communication link between vehicles in the consist may be other than an electrical power transmission line. In particular, the physical communication link may be a cable or other electrical conductor extending between plural and/or adjacent passenger cars, other than an electrical power transmission line. For example, the physical communication link may be any suitable wire (or plural wires) carrying high power, low power, small control voltages, or no other electrical signal whatsoever.

An embodiment relates to a communication system for communicating data in a vehicle consist. The system comprises a first unit on a first vehicle in the vehicle consist and a second unit on a second vehicle in the vehicle consist. The first and second units are electrically coupled to an electrical power transmission line in the vehicle consist that interconnections adjacent vehicles. For example, the electrical power transmission line may be an existing line used in the vehicle consist for transferring electrical power to the vehicles in the vehicle consist. The first and second units are configured to transmit and/or receive at least one of high-bandwidth data or network data over the electrical power transmission line.

In another embodiment of the communication system, the first and second units are configured to convert the network data into modulated network data for transmission over the electrical power transmission line, and to de-modulate modulated network data received over the electrical power transmission line back into network data, for use in communicating data between electronic components in the vehicle consist or otherwise.

In an embodiment, the first and second units are router transceiver units. Each of the router transceiver units comprise a network adapter module electrically connected to an electronic component and a signal modulator module having an electrical output for electrical connection to the electrical power transmission line.

In an embodiment, the first and second units are configured to measure a length of the vehicle consist by measuring at least one event between a front vehicle and a rear vehicle in the vehicle consist, assess consist integrity through at least one of continuous or polling communications with a rear vehicle in the vehicle consist, determine a position of one or more vehicles in the consist by synchronizing one or more measured events, and/or determine a relationship, such as a distance, between the first vehicle and the second vehicle.

In other embodiments, the first unit is configured to determine that a first electronic component in the first vehicle is in a failure state. The system further comprises a first data transmitter module configured to transmit the high-bandwidth or network data from the first vehicle to the second vehicle in response to the first unit determining that the first electronic component is in the failure state.

In yet other embodiments, the first and second units are configured to transmit video data over the electrical power transmission line and to display or process the video data for clearing doors at an unload/load platform and/or are controlled to access one or more of redundant communications, public information systems and train control equipment over the electrical power transmission line.

Another embodiment relates to a data communications network for passenger vehicles in a vehicle consist. The system comprises a first unit on a first passenger vehicle in the vehicle consist and a second unit on a second passenger vehicle of the consist. The first and second units are coupled to an electrical power transmission line in the vehicle consist that interconnects adjacent passenger vehicles. The electrical power transmission line is an existing line used in the vehicle consist for transferring electrical power to the passenger vehicles in the vehicle consist. The first and second units are configured to transmit and/or receive at least one of network data or high-bandwidth data over the electrical power transmission line.

Another embodiment relates to a communication system for communicating data in a vehicle consist. The system comprises a first unit configured for operable coupling with an electrical power transmission line in a first vehicle. The electrical power transmission line is configured to interconnect the first vehicle with adjacent vehicles in the vehicle consist for transferring electrical power within the vehicle consist when the first vehicle is mechanically coupled to the adjacent vehicles. The first unit is further configured to transmit and/or receive at least one of high-bandwidth data or network data over the electrical power transmission line. In an embodiment, electrical power is non-data electricity, meaning electricity that is not used to convey information.

In another embodiment, the first unit is configured to measure a length of the vehicle consist by measuring at least one event between a front vehicle and a rear vehicle in the vehicle consist, assess consist integrity through at least one of continuous or polling communications with a rear vehicle in the vehicle consist, verify a status of the vehicle consist by polling one or more vehicles in the consist, determine a position of one or more vehicles in the vehicle consist by synchronizing one or more measured events, and/or determine a relationship, such as a distance, between the first vehicle and the second vehicle.

In another embodiment, the first unit is configured to determine that a first electronic component in the first vehicle is in a failure state. The system further comprises a first data transmitter module configured to transmit the high-bandwidth or network data from the first vehicle to the second vehicle in response to the first unit determining that the first electronic component is in the failure state.

In another embodiment, the first unit is configured to convert the network data into modulated network data for transmission over the electrical power transmission line and to demodulate the modulated network data received over the electrical power transmission line for use by electronic components in the vehicles of the vehicle consist.

In another embodiment, the first unit is a router transceiver unit. The router transceiver unit comprises a network adapter module electrically connected to an electronic component, and a signal modulator module having an electrical output for electrical connection to the electrical power transmission line.

In yet other embodiments, the first unit is configured to transmit video data over the electrical power transmission line and to display or process the video data for clearing doors at an unload/load platform and/or are controlled to access one or more of redundant communications, public information systems and train control equipment over the electrical power transmission line.

Any of the aforementioned embodiments are also applicable for communicating data in vehicle consists generally. Moreover, in any of the aforementioned embodiments, the vehicle consist may be a passenger vehicle consist comprising a plurality of passenger vehicles.

Another embodiment relates to a method comprising at least one of transmitting or receiving at least one of high-bandwidth data or network data over an electrical power transmission line that interconnects a first passenger vehicle of a passenger vehicle consist with a second passenger vehicle of the passenger vehicle consist for transfer of electrical power between the first and second passenger vehicles. The electrical power transmission line may be an existing electrical power transmission line, e.g., an electrical power transmission line that was in place for transfer of the electrical power before equipment was added to effectuate data transfer over the electrical power transmission line.

As noted above, in embodiments, the physical communication link is a cable or other electrical conductor extending between plural and/or adjacent passenger cars, other than an electrical power transmission line. In one embodiment, for example, a communications system comprises a first unit (e.g., a first router transceiver unit, as described herein) on a first vehicle of the vehicle consist, and a second unit (e.g., a second router transceiver unit, as described herein) on a second vehicle of the vehicle consist. The first and second units are coupled to an electrical conductor in the vehicle consist that interconnects adjacent vehicles. The first and second units are configured to transmit and/or receive at least one of high-bandwidth data or network data over the electrical conductor. In another embodiment of a communication system, as another example, the system comprises a first unit (e.g., a first router transceiver unit, as described herein) on a first passenger vehicle in the vehicle consist, and a second unit (e.g., a second router transceiver unit, as described herein) on a second passenger vehicle of the vehicle consist. The first and second unit are coupled to an electrical conductor in the vehicle consist that interconnects adjacent passenger vehicles. The first and second units are configured to transmit and/or receive at least one of network data or high-bandwidth data over the electrical conductor. In another embodiment of a communication system, as yet another example, the system comprises a first unit (e.g., a router transceiver unit, as described herein) configured for operable coupling with an electrical conductor in a first vehicle, which interconnects the first vehicle with adjacent vehicles in the vehicle consist (e.g., for transferring electric signals) when the first vehicle is mechanically coupled to the adjacent vehicles. The first unit is configured to transmit and/or receive at least one of high-bandwidth data or network data over the electrical conductor.

In another embodiment of a communication system for a vehicle consist, a communications system comprises a first unit (e.g., a first router transceiver unit, as described herein) on a first vehicle of the vehicle consist, and a second unit (e.g., a second router transceiver unit, as described herein) on an end vehicle of the vehicle consist (that is, the least vehicle of the consist, in a direction of travel of the consist). For example, the end vehicle might be an end passenger vehicle, and/or an end vehicle that does not have an on-board computer-based control system, other control system, or other particular device. The first and second units are coupled to an electrical conductor in the vehicle consist that interconnects the vehicles. The first and second units are configured to transmit and/or receive at least one of network data or high-bandwidth data over the electrical conductor. Additionally, the second unit on the end vehicle may be configured to perform (and/or may facilitate other equipment performing): (i) one or more functions that a computer-based control system, other control system, or other device would normally perform, but that are otherwise unavailable to the end vehicle because it lacks the on-board computer-based control system, other control system, or other device; and/or (ii) one or more functions that are otherwise unavailable to the end vehicle because it lacks a suitable communication link to other vehicles in the consist. For example, an end-of-train unit could be operably coupled in the end vehicle, including connection to the second unit, for communications between the end-of-train unit and other vehicles in the consist (e.g., the end-of-train unit could be configured for a consist integrity function). As another example, the second unit in the end vehicle could itself be configured for a consist length determination function and/or a consist integrity function, with the end vehicle (in some embodiments) lacking such functions but for the second unit. As other examples, the end vehicle may be a passenger vehicle, and the first vehicle may be a locomotive and/or a first-in-line vehicle in the consist.

Similarly, in other embodiments, in cases where a first unit is on a first vehicle in a consist and a second unit is on a second vehicle in a consist, the second unit may be configured to perform (and/or may facilitate other equipment performing): (i) one or more functions that a computer-based control system, other control system, or other device would normally perform, but that are otherwise unavailable to the second vehicle because it lacks the on-board computer-based control system, other control system, or other device (for example); and/or (ii) one or more functions that are otherwise unavailable to the second vehicle because it lacks a suitable communication link to other vehicles in the consist. As an example, the first vehicle may be a first-in-line vehicle (such as a lead locomotive), and the second vehicle may be a passenger vehicle in the consist that is not at the end of the consist.

As should be appreciated, this method and system is applicable to communicating data between any of the linked vehicles 18a-18c, and thereby the terms “first” and “second” vehicle are used to identify respective vehicles in the vehicle consist and are not meant to characterize an order or position of the vehicles unless otherwise specified. That being said, it may be the case that the first and second vehicles are adjacent to and mechanically coupled with one another.

In any of the embodiments set forth herein, the network data may be TCP/IP-formatted or SIP-formatted data. Additionally, each vehicle may include a computer unit, with the computer units 32a-32c communicating with one another by transmitting the network data, formatted as TCP/IP data or SIP data or otherwise, over the existing electrical power transmission line 26, and the computer units thereby forming a computer network, e.g., an Ethernet-type network.

In any of the embodiments set forth herein, the data transmitted over the electrical power transmission line may additionally or alternatively be “high bandwidth” data, meaning data transmitted at average rates of 10 Mbit/sec or greater. (In one aspect, the data is high bandwidth data. In another aspect, the data is network data. In another aspect, the data is both high bandwidth data and network data, referred to herein as “high bandwidth network data,” meaning data that is packaged in packet form as data packets and transmitted over the electrical power transmission line at average rates of 10 Mbit/sec or greater.) This reflects that the communication system (and associated method) are applicable for realizing a high information density communication environment in a passenger vehicle consist, i.e., it is possible to exchange relatively large amounts of data between passenger vehicles in a timely manner. In contrast, “low bandwidth” data is data transmitted at average rages of less than 10 Mbit/sec, and “very low bandwidth” data (a type of low bandwidth data) is data transmitted at average rates of 1200 bits/sec or less.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present invention will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described system and method for communicating data in a passenger vehicle consist, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A communication system for communicating data in a vehicle consist, the system comprising:
a first unit on a first vehicle of the vehicle consist; and
a second unit on a second vehicle of the vehicle consist;
wherein the first and second units are coupled to an electrical power transmission line in the vehicle consist that interconnects adjacent vehicles, the electrical power transmission line being an existing line used in the vehicle consist for transferring electrical power to the vehicles in the vehicle consist; and
wherein the first and second units are configured to transmit and/or receive at least one of high-bandwidth data or network data over the electrical power transmission line.

2. The system of claim 1, wherein:
the first and second units are configured to convert the network data into modulated network data for transmission over the electrical power transmission line and to demodulate the modulated network data received over the electrical power transmission line for use by electronic components in the vehicles of the vehicle consist.

3. The system of claim 2, wherein:
the vehicle consist is a passenger vehicle consist and the first vehicle and the second vehicle are passenger vehicles.

4. The system of claim 1, wherein:
the first and second units are router transceiver units each comprising a network adapter module electrically connected to an electronic component, and a signal modulator module having an electrical output for electrical connection to the electrical power transmission line.

5. The system of claim 1, wherein:
the first and second units are configured to measure a length of the vehicle consist by measuring at least one event between a front vehicle and a rear vehicle in the vehicle consist.

6. The system of claim 1, wherein:
the first and second units are configured to assess consist integrity through at least one of continuous communications or polling communications with a rear vehicle in the vehicle consist.

7. The system of claim 1, wherein:
the first and second units are configured to verify a status of the vehicle consist by polling one or more vehicles in the vehicle consist.

8. The system of claim 1, wherein:
the first and second units are configured to determine a position of one or more vehicles in the vehicle consist by synchronizing one or more measured events.

9. The system of claim 1, wherein:
the first unit is configured to determine that a first electronic component in the first vehicle is in a failure state, wherein in the failure state the first electronic component is unable to perform a designated function of the first electronic component; and
wherein the system further comprises a first data transmitter module configured to transmit the at least one of the high-bandwidth data or the network data from the first vehicle to the second vehicle in response to the first unit determining that the first electronic component is in the failure state.

10. The system of claim 1, wherein:
at least one of the first unit or the and second unit is configured for determining a relationship between the first vehicle and the second vehicle.

11. The system of claim 10, wherein:
the relationship is a physical relationship comprising a distance between the first vehicle and the second vehicle.

12. The system of claim 10, wherein:
the first and second units are configured to transmit video data over the electrical power transmission line; and
wherein the system is configured to at least one of display or process the video data for clearing doors at an unload/load platform.

13. The system of claim 10, wherein:
the first and second units are controlled to access one or more of redundant communications, public information systems, or train control equipment over the electrical power transmission line.

14. A data communications network for passenger vehicles in a vehicle consist, comprising:
a first unit on a first passenger vehicle in the vehicle consist; and
a second unit on a second passenger vehicle of the vehicle consist;
wherein the first and second unit are coupled to an electrical power transmission line in the vehicle consist that interconnects adjacent passenger vehicles, the electrical power transmission line being an existing line used in the vehicle consist for transferring electrical power to the passenger vehicles in the vehicle consist; and
wherein the first and second unit are configured to transmit and/or receive at least one of network data or high-bandwidth data over the electrical power transmission line.

15. A communication system for communicating data in a vehicle consist, the system comprising:
a first unit configured for operable coupling with an electrical power transmission line in a first vehicle, the electrical power transmission line configured to interconnect the first vehicle with adjacent vehicles in the vehicle consist for transferring electrical power within the vehicle consist when the first vehicle is mechanically coupled to the adjacent vehicles;
wherein the first unit is configured to transmit and/or receive at least one of high-bandwidth data or network data over the electrical power transmission line.

16. The system of claim 15, wherein:
at least one of the first vehicle or one or more of the adjacent vehicles is a passenger vehicle.

17. The system of claim 15, wherein:
the first unit is configured to convert the network data into modulated network data for transmission over the electrical power transmission line and to demodulate the modulated network data received over the electrical power transmission line for use by electronic components in the vehicles of the vehicle consist.

18. The system of claim 15, wherein:
the first unit is a router transceiver unit comprising a network adapter module electrically connected to an electronic component, and a signal modulator module having an electrical output for electrical connection to the electrical power transmission line.

19. The system of claim 15, wherein:
the first unit is configured to measure a length of the vehicle consist by measuring at least one event between a front vehicle and a rear vehicle in the vehicle consist.

20. The system of claim 15, wherein:
the first unit is configured to assess consist integrity through at least one of continuous communications or polling communications with a rear vehicle in the vehicle consist.

21. The system of claim 15, wherein:
the first unit is configured to verify a status of the vehicle consist by polling one or more vehicles in the vehicle consist.

22. The system of claim 15, wherein:
the first unit is configured to determine a position of one or more vehicles in the vehicle consist by synchronizing one or more measured events.

23. The system of claim 15, wherein:
the first unit is configured to determine that a first electronic component in the first vehicle is in a failure state, wherein in the failure state the first electronic component is unable to perform a designated function of the first electronic component; and
wherein the system further comprises a first data transmitter module configured to transmit the at least one of the high-bandwidth data or the network data from the first electronic component to a second electronic component in response to the first unit determining that the first electronic component is in the failure state.

24. The system of claim 15, wherein:
the first unit is configured to determine a relationship between the first vehicle and at least one passenger vehicle in the vehicle consist.

25. The system of claim 24, wherein:
the relationship is a physical relationship comprising a distance between the first vehicle and the at least one passenger vehicle in the vehicle consist.

26. The system of claim 15, wherein:
the first unit is configured to transmit video data over the electrical power transmission line; and
wherein the system is configured to at least one of display or process the video data for clearing doors of a passenger vehicle of the vehicle consist at an unload/load platform.

27. The system of claim 15, wherein:
the first unit is controlled to access one or more of redundant communications, public information systems, or train control equipment over the electrical power transmission line.
